(19) United States
(12) Patent Application Publication
(10) Pub. No.: US 2004/0245856 A1
(43) Pub. Date: Dec. 9, 2004

(54) Electrical switching device for preventing error pushing

(76) Inventor: Shoei-Lai Chen, Taipei (TW)

Correspondence Address: TSENG, YI WEN, 509 ROOSEVELT BLVD. #D306, FALL CHURCH, VA, 22044, US

(21) Appl. No.: 10/456,622

(22) Filed: Jun. 9, 2003

(51) Int. Cl. H01H 3/00

(52) U.S. Cl. 307/139

(57) ABSTRACT

A switching device includes two pushbutton switches to turn on/off an apparatus or to enable the apparatus to be turned on/off by a third switch by simultaneously pushing both two pushbutton switches for a predetermined time. It is suitable for the large apparatus as well as for the small and compact apparatus such as a remoter. Furthermore, it can also prevent child for purposely pushing the switch button. Therefore, it can provide an excellent protection to prevent error pushing.

### BACKGROUND OF THE INVENTION

The present invention relates generally to an electrical switching device for preventing error pushing and, more particularly, to an electrical switching device including two pushbutton switches to turn on/off an apparatus or to enable the apparatus to be turned on/off by a third switch by simultaneously pushing both two pushbutton switches for a predetermined time, thereby the apparatus will not be turned on/off by an erroneous pushing operation.

It is well-know an on/off switch for an electrical or mechanical apparatus with dangerous or precise performance, such as a laser pointer, a motor, a security monitoring system, and a switchboard or even a missile controlling system and etc., having the design for preventing error pushing. However, the conventional switching device always utilizes a mechanical protection. For example, it may have the switch with secure device, may need inserting a key or other specific tool so as to push the switch button, may have to rotate the switch button to be pushed, or may have a lid to protect the button and etc. However, these kind of switches will occupy larger space and much cost, and are not easy for operation. Therefore, it may not suitable for a hand-held apparatus such as a remoter, a laser pointer, a laptop computer, a mobile phone or a personal digital assistant (PDA) and etc. Nevertheless, there is an anti-error pushing design for the remoter, that is, a specific switch button is installed on the housing with the button surface at or beneath the surface of the housing. Therefore, the switch button is not easy to be pushed. Using this kind of protection needs only to change the installation of the button; therefore, it is somehow practical. However, it is not good enough because it is still happened to purposely push the button to activate the apparatus by child. On the other hand, for example, the hand-held laser pointer, which is similarly operated as the remoter, maybe too compact to be installed the above-mentioned mechanical protection for the error pushing purpose. However, the laser pointer can emit a laser beam. Although the beam is not so strong, it still can damage eyes of a person in short distance and cause a permanent and serious harm. Therefore, it is really important to provide the switch with error pushing protection for those laser pointer and other similar apparatus. However, it still has not perfect solution for that so far.

### BRIEF SUMMARY OF THE INVENTION

The present invention provides an electrical switching device for preventing error pushing, including two pushbutton switches to turn on/off an apparatus or to enable the apparatus to be turned on/off by a third switch by simultaneously pushing both two pushbutton switches for a predetermined time. It is suitable for the large apparatus as well as for the small and compact apparatus such as a remoter. Furthermore, it can also prevent child for purposely pushing the switch button.

### BRIEF DESCRIPTION OF THE DRAWINGS

These, as well as other features of the present invention, will become more apparent upon reference to the drawings wherein:

FIG. 1 shows a block diagram of the present invention;

FIG. 2 is a circuit diagram of a preferred embodiment according to the present invention;

FIG. 3 is a circuit diagram of another preferred embodiment according to the present invention.

### DETAILED DESCRIPTION OF THE INVENTION

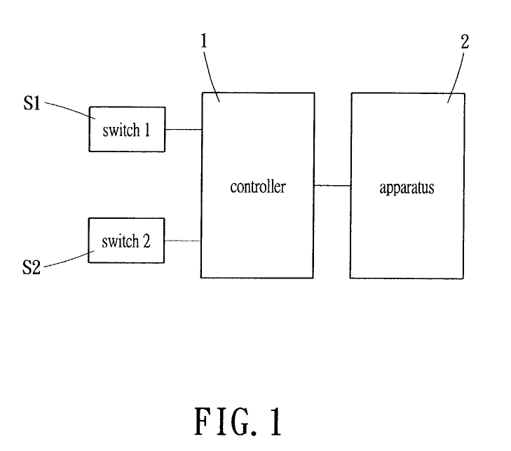

Referring to FIG. 1, it shows a block diagram of an electrical switching device for preventing error pushing according to the present invention. It includes two switches S1 and S2 electronically connecting to a controller 1. An apparatus 2 under the activation of the switches S1 and S2 for controlling is connected to the controller 1. The switches S1 and S2 are normal open/close snap-acting pushbutton switches. That is, only while the switch is pushed to change the initial open/close status to opposite close/open status, otherwise, the switch will return to its initially normal open/close status. The switches S1 and S2 can be selected from a group of mechanical switches or membrane switches etc. The controller 1 can be a microprocessor or other equivalent controlling circuits. The controller 1 is to acknowledge both of the switches S1 and S2 being simultaneously pushed for a predetermined time, such as about 1 to 3 seconds, and then sends a control signal to the apparatus 2 for turning on or off the apparatus 2. Instead, the control signal can be sent to the apparatus 2 for enabling the apparatus 2 to be turn on or off by further pushing one of the switches S1 and S2 or another switch.

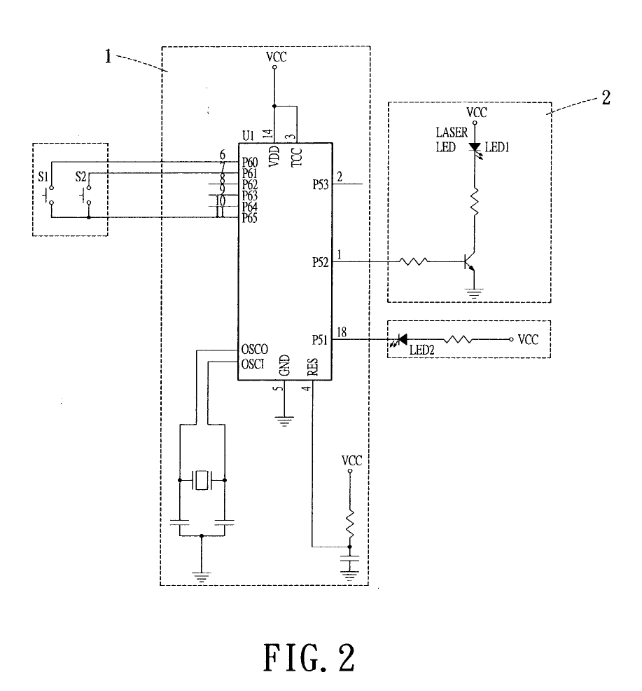

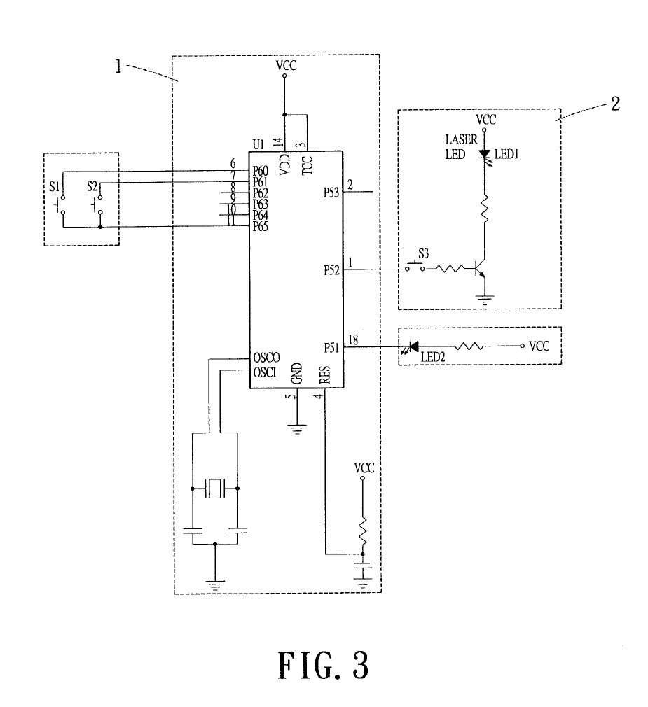

Please refer to FIG. 2, it shows a preferred embodiment of the present invention used in a laser pointer. It includes a microprocessor U1 as the controller 1, and two snap-acting pushbutton switches S1 and S2 with normal open status connected to the controller 1. The controller 1 controls the laser pointer 2 by sending the control signal to enable the laser pointer 2 while both of the switches S1 and S2 are pushed simultaneously for a predetermined time. Meanwhile, it can further include a display device, such as a light emitting diode LED2 and/or a sound device to inform that the laser pointer 2 is at the enabling status. Therefore, it can further push a predetermined switch selected from one of the switches S1 and S2 to turn on or off the laser pointer 2. For another preferred embodiment as shown in FIG. 3, after two switches S1 and S2 are pushed, there is another switch S3 for turning on or off the laser pointer 2. In the present invention, if two switches S1 and S2 are not pushed at the same time, there is no chance to activate the laser pointer. It is hardly possible for child even to purposely push the switch button to activate the apparatus. Therefore, the present invention can provide an excellent protection for use in any large or hand-held apparatus. Further, the present invention provides a switching device without using any special switch, and does not occupy space and cost.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. A switch device for turning on/off an apparatus, including
two snap-acting pushbutton switches; and
a controller electronically connecting to the two switches and the apparatus, for acknowledging both of the two switches being simultaneously pushed for a predetermined time so as to send a control signal to the apparatus for turning on/off the apparatus.

2. The switch device as claimed in claim 1, wherein the two switches are normal open or normal close switches.

3. The switch device as claimed in claim 1, wherein the controller is a microprocessor.

4. The switch device as claimed in claim 1, wherein the predetermined time is about 1 to 3 seconds.

5. A switch device for turning on/off an apparatus, including
two snap-acting pushbutton switches; and
a controller electronically connecting to the two switches and the apparatus, for acknowledging both of the two switches being simultaneously pushed for a predetermined time so as to send a control signal to the apparatus for enabling the apparatus to be turned on/off by further pushing one of the two switches.

6. The switch device as claimed in claim 5, wherein the two switches are normal open or normal close switches.

7. The switch device as claimed in claim 5, wherein the controller is a microprocessor.

8. The switch device as claimed in claim 5, wherein the predetermined time is about 1 to 3 seconds.

9. The switch device as claimed in claim 5, further comprising a display device connected to the controller, for showing the apparatus being enabled.

10. The switch device as claimed in claim 9, wherein the display device is a light emitting diode (LED).

11. The switch device as claimed in claim 9, further comprising a sound device for showing the apparatus being enabled.

12. The switch device as claimed in claim 5, further comprising a sound device for showing the apparatus being enabled.

13. A switch device for turning on/off an apparatus, including
two snap-acting pushbutton switches and a third switch; and
a controller electronically connecting to the two switches, the third switch and the apparatus, for acknowledging both of the two switches being simultaneously pushed for a predetermined time so as to send a control signal to the apparatus for enabling the apparatus to be turned on/off by further pushing the third switch.

14. The switch device as claimed in claim 13, wherein the two switches are normal open or normal close switches.

15. The switch device as claimed in claim 13, wherein the controller is a microprocessor.

16. The switch device as claimed in claim 13, wherein the predetermined time is about 1 to 3 seconds.

17. The switch device as claimed in claim 13, further comprising a display device connected to the controller, for showing the apparatus being enabled.

18. The switch device as claimed in claim 17, wherein the display device is a light emitting diode (LED).

19. The switch device as claimed in claim 17, further comprising a sound device for showing the apparatus being enabled.

20. The switch device as claimed in claim 13, further comprising a sound device for showing the apparatus being enabled.
